(19) United States
(12) Patent Application Publication
(10) Pub. No.: US 2025/0242919 A1
(43) Pub. Date: Jul. 31, 2025

(54) CONVERTIBLE CUP HOLDER

(71) Applicant: SPAIR CUPS, LLC, Allendale, NJ (US)

(72) Inventor: Edward James Blackmon, Allendale, NJ (US)

(21) Appl. No.: 19/011,703

(22) Filed: Jan. 7, 2025

Related U.S. Application Data
(60) Provisional application No. 63/627,013, filed on Jan. 30, 2024.

(51) Int. Cl. B64D 11/06

(52) U.S. Cl. CPC B64D 11/0638

(57) ABSTRACT

A convertible cup holder is provided. The convertible cup holder is especially suitable for use while traveling, such as on an airplane tray. The convertible cup holder may have a first unit and a second unit connected by a hinge wherein the second unit may fold or rotate from a first position to a second position with respect to the first unit. A suction or “anti-slip” material is located on the bottom of at least one or both of the units to secure the cup holder to a surface. An opening in the first and or second unit may receive cup having a beverage.

### CROSS REFERENCE TO RELATED APPLICATIONS

The following application is a based on and claims the priority benefit of U.S. provisional application Ser. No. 63/627,013 filed Jan. 30, 2024 currently; the entire content of which is incorporated by reference.

### BACKGROUND OF THE INVENTION

A convertible cup holder is provided. The convertible cup holder is especially suitable for use while traveling, such as on an airplane tray. The convertible cup holder may have a first unit and a second unit connected by a hinge wherein the second unit may fold or rotate from a first position to a second position with respect to the first unit. A suction or “anti-slip” material is located on the bottom of at least one or both of the units to secure the cup holder to a surface. An opening in the first and or second unit may receive cup having a beverage.

Cup holders are common. For example, U.S. Pat. No. 11,246,437 to Taylor discloses a weighted cup holder with a weighted bag-like flexible base member that has a generally toroidal shape and a separate cup holder member. The base member and the cup holder member are configured to be removably coupled together into an assembly. When the assembly is placed on a surface, the cup holder member sits on the surface and the base member sits on part of the cup holder member and so acts to stabilize the cup holder member. A drink holder such as a bottle, glass or cup can be placed into and held in the cup holder member.

Further, U.S. Pat. No. 11,084,589 to Mansker discloses a cooled cup holder having a cooled beverage container that is connectable to a vehicle's air conditioning system to maintain a drink cold. The assembly can additionally be provided with a second compartment which can keep a snack or sandwich cool. The cup holder assembly can be adapted to be suspended from the map pocket panel, or can be provided with its own map pocket, in which case, the assembly will replace the airplane's map pocket.

However, these patents fail to describe a convertible cup holder which is easy to use. Further, these patents fail to provide for a convertible cup holder may be used in an efficient manner.

### SUMMARY OF THE INVENTION

A convertible cup holder is provided. The convertible cup holder is especially suitable for use while traveling, such as on an airplane tray. The convertible cup holder may have a first unit and a second unit connected by a hinge wherein the second unit may fold or rotate from a first position to a second position with respect to the first unit. A suction or “anti-slip” material is located on the bottom of at least one or both of the units to secure the cup holder to a surface. An opening in the first and or second unit may receive cup having a beverage.

An advantage of the present cup holder is that the present cup holder is convertible and easily transportable.

Another advantage of the present cup holder is that the present cup holder is light-weight.

Still another advantage of the present cup holder is that the present cup holder is easily securable to a flat surface.

And another advantage of the present cup holder is that the present cup holder may be folded from a first orientation to a second orientation.

For a more complete understanding of the above listed features and advantages of the present cup holder reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a perspective view of the convertible cup holder in a first position (the open position).

FIG. 2 illustrates a perspective view of the first unit of the convertible cup holder wherein a cup is in the process of being inserted into the cup holder.

FIG. 3 illustrates an exploded view of the convertible cup holder.

FIG. 4 illustrates a top view of the convertible cup holder.

FIG. 5 illustrates a bottom view of the convertible cup holder.

FIG. 6 illustrates a side view of the convertible cup holder in the open orientation.

FIG. 7 illustrates a side view of an alternative wider convertible cup holder.

FIG. 8 illustrates a side view of the convertible cup holder of FIG. 6 in the folded orientation.

### DETAILED DESCRIPTION OF THE PREFERRED EMBODIMENTS

A convertible cup holder is provided. The convertible cup holder is especially suitable for use while traveling, such as on an airplane tray. The convertible cup holder may have a first unit and a second unit connected by a hinge wherein the second unit may fold or rotate from a first position to a second position with respect to the first unit. A suction or “anti-slip” material is located on the bottom of at least one or both of the units to secure the cup holder to a surface. An opening in the first and or second unit may receive cup having a beverage.

Referring now to the drawings, a convertible cup holder 1 is provided. The convertible cup holder 1 is preferably made of a durable material such as, plastic, rubber, metal or the like. In an embodiment, the convertible cup holder 1 may have a first unit 10 and a second unit 50. The first unit 10 may have a top 11, a bottom 12, a front 13, a back 14, a first side 15 and a second side 16. The second unit 50 may have a top 51, a bottom 52, a front 53, a back 54, a first side 55 and a second side 56.

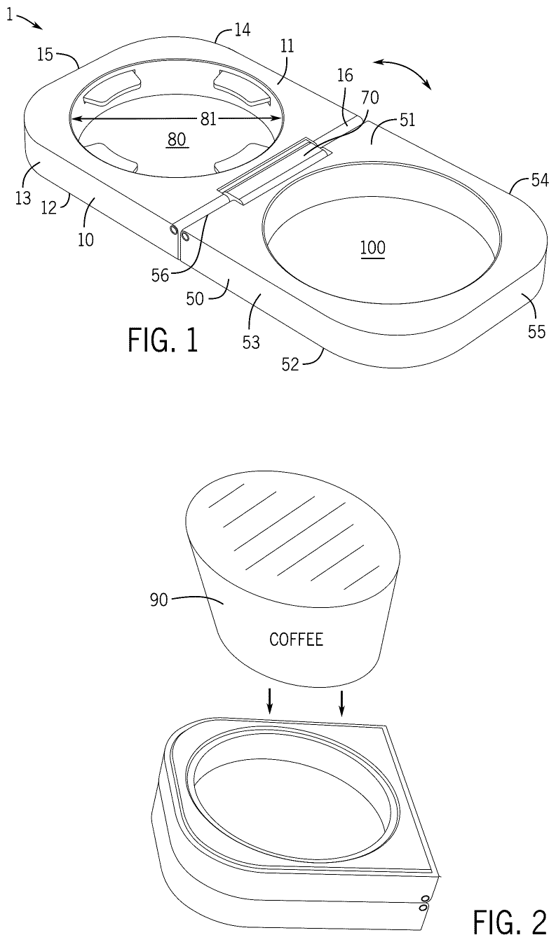

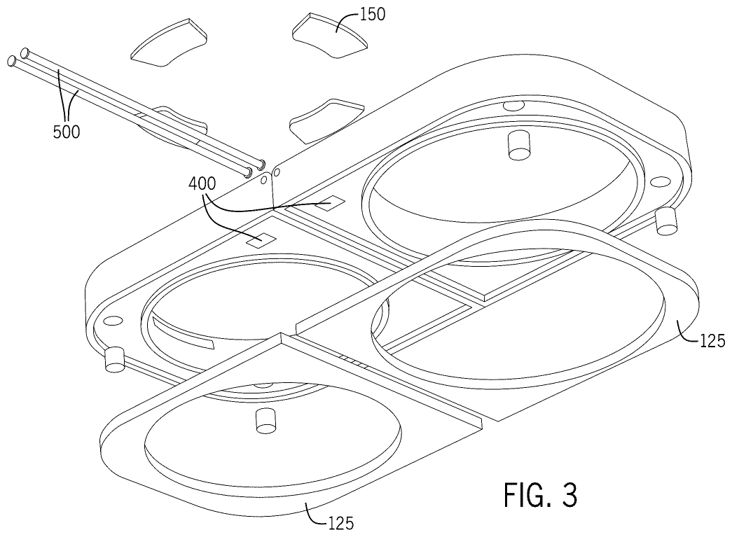

In an embodiment, the first unit 10 and the second unit 50 may be separated by a hinge 70 which allows the second unit 50 to rotate up to one hundred and eighty degrees with respect to the first unit 10. The hinge 70 may be secured to two internal rods 500 located within the first unit 10 and the second unit 50. The hinge 70 may allow the device 1 to move from a first (“open”) position (FIG. 1) to a second (“folded”) position (FIG. 8). In the second position, the second unit 50 is folded on top of the first unit 10 and the device 1 is approximately twice as tall and takes up approximately one-half the resting surface area on the bottom. The second position is especially suitable for carrying the device 1 and is also especially suitable for holding tall cups 90 (as described below).

In one embodiment, the first unit 10 may have an opening 80. In an embodiment, the opening 80 is generally circular having a diameter 81. The diameter 81 is preferably similar to or slightly larger than the diameter of a typical beverage can 90, bottle or cup so that the beverage can 90 or the like may be placed within the opening 80 of the first unit 10. In an embodiment, the opening 80 extends completely through the first unit 10, from the top 11 to the bottom 12 of the first unit 10 so that the opening 80 creates a hole in which an object may completely pass through the first unit 10. In an alternative embodiment, the opening 80 has a bottom (not illustrated) at or near the bottom 12 of the first unit 10 so that the beverage 10 can rest on the bottom of the opening 80. In an embodiment, the second unit 50 may have an opening 100 which is similar to or identical to the opening 80 of the first unit 10. As a result, the device 1 may hold two beverages 90 (as described below) at the same time when the device 1 is in the first orientation of FIG. 1.

In an embodiment, the first unit 10 may have a grasping mechanism 125. The grasping mechanism 125 is located at the bottom 12 of the first unit 10 and may also be present on the bottom 52 of the second unit 50. In an embodiment, the grasping mechanism 125 of the first unit 10 has a suction device or anti-slip material which attaches the device 1, via suction force, to a surface 200 such as, for example, an airplane seat tray. When the grasping mechanism 125 is secured to the surface 200, and a beverage 90 is placed into one or both openings 80, 100, the beverage 90 is secured and the chance of the beverage 90 sliding or tipping over is greatly reduced. In an embodiment, the grasping mechanism is made of a rubber which has a sticky quality so that the rubber lightly sticks to the surface 200 and is helps prevent the movement of the device 1.

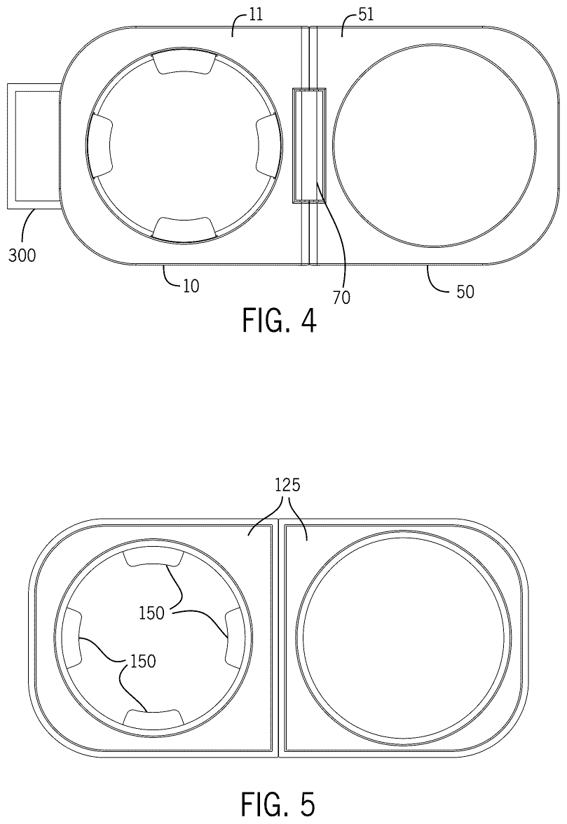

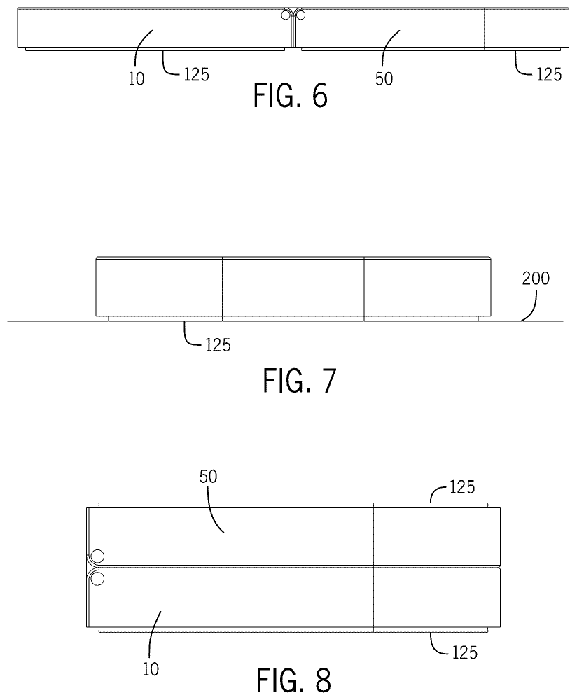

In one optional alternative embodiment (shown in FIG. 4), first side 15 of the first unit 10 may have an optional storage compartment 300. The optional storage compartment 300 may be, for example, an elongated indentation which allows a user to temporarily store an item such as, for example, a cell phone, in an upright position.

In an embodiment, at least the first opening 80 may have bendable securing tabs 150. The bendable securing tabs 150 may be made of a bendable material such as rubber or plastic. The bendable securing tabs 150 may allow a user to secure a cup 90 with a large or a small diameter into the opening 80, 100 of the device 1. More specifically, the bendable securing tabs 150 may help grasp the cup 90 and secure the cup 90 within the openings 90, 150. Further, in an embodiment, the opening 80 of the first unit 10 may have tabs 150 for securing beverages of different sizes whereas the opening 100 of the second unit 50 may lack tabs 150 and may have a diameter slightly greater than the diameter of a standard twelve once soda can for securing the twelve once soda can.

In an alternative embodiment, the bottoms 12, 52 of the first unit 10 and second unit 50 may have optional magnets 400. The optional magnetics 400 may help secure the device 1 to a surface 200 which is metal so as to better secure the device 1 and prevent the device 1 from moving and, therefore, spilling the contents of the cup 90. Still further, the magnets 400 may be used to secure the device 1 together in the folded or closed orientation of FIGS. 2 or 8.

In an embodiment, the hinge 70 may be removed from the securing rods 500 so that the first unit 10 and the second unit 50 are completely separated. More specifically, the hinge 70 may be secured to the rods 500 via friction, but may be removed from the rods 500 by a user pulling upward on the hinge 70. Once separated, a user may elect to only use either the first unit 10 or the second unit 500. The hinge 70 may be returned to the rods 500 if the user later wishes to use both the first unit 10 and the second unit 50 (as shown in FIGS. 1 or 8.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A convertible cup holder comprising:
a first unit housing having a top, a bottom, a front, a back, a first side, a second side and an opening having a diameter;
a second unit housing having a top, a bottom, a front, a back, a first side, a second side and an opening having a diameter;
a hinge connecting the first unit to the second unit wherein the hinge allows the first unit to rotate with respect to the second unit from a first orientation to a second orientation; and
wherein the opening of the first unit and the opening of the second unit are capable of securing a beverage container.

2. The convertible cup holder of claim 1 further comprising:
at least one securing tab located within the opening of the first housing unit wherein the tab is capable of securing a beverage container.

3. The convertible cup holder of claim 2 wherein the securing tab is made of rubber.

4. The convertible cup holder of claim 2 wherein the securing tab is flexible.

5. The convertible cup holder of claim 1 further comprising:
a magnet located on the bottom of the first unit.

6. The convertible cup holder of claim 1 further comprising:
a magnet located on the bottom of the second unit.

7. The convertible cup holder of claim 1 further comprising:
a magnet on the bottom of the first unit and a magnet located on the bottom of the second unit wherein the magnet on the bottom of the first unit is attracted to the magnet on the bottom of the second unit and wherein the magnets of the first unit and the second unit temporarily and removably secure the convertible cup holder in a folded orientation.

8. The convertible cup holder of claim 1 further comprising:
an anti-slip material located on the bottom of the first unit and the bottom of the second unit.

9. The convertible cup holder of claim 1 further comprising:
a storage compartment attached to the first unit or the second unit.

10. The convertible cup holder of claim 1 wherein the hinge is removable and wherein the removal of the hinge separates the first unit from the second unit.

11. The convertible cup holder of claim 1 wherein the second unit rotates one hundred and eighty degrees with respect to the first unit.
